(19) United States
(12) Patent Application Publication
(10) Pub. No.: US 2013/0068200 A1
(43) Pub. Date: Mar. 21, 2013

(54) Injector Valve with Miniscule Actuator Displacement

(71) Applicants: Paul Reynolds, Mountain View, CA (US); Robert Andrew Banks, Mountain View, CA (US)

(72) Inventors: Paul Reynolds, Mountain View, CA (US); Robert Andrew Banks, Mountain View, CA (US)

(21) Appl. No.: 13/233,576

(22) Filed: Sep. 15, 2011

(51) Int. Cl. F02M 51/00; F16K 31/02

(52) U.S. Cl. 123/472; 239/585.1; 251/129.01

(57) ABSTRACT

An injector comprising one or more piezoelectric driving stacks wherein a flow control member of the injector is driven directly by the one or more piezoelectric stacks without additional amplification means or interposing elements while a flow area of the nozzle is variably adjustable to deliver controlled flow rates in a desired flow profile to improve engine performance and reduce emissions. The injector is configured to support required flow rates with minimal linear movement of the flow control member. The injector and drive electronics are configured to deliver higher frequency operation and response with increased operational stability due to minimal response lag.

### STATEMENT REGARDING FEDERALLY SPONSORED RESEARCH OR DEVELOPMENT

This invention was made with government support under U.S. Navy Contract Number N00014-08-C-0546 awarded by the Office of Naval Research. The government has certain rights in the invention.

### CROSS REFERENCE TO RELATED APPLICATIONS

None.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### BACKGROUND

1. Field of the Invention

The present invention relates to fluid injection valves. More particularly, the present invention is related to fluid injection valves directly actuated by a piezoelectric stack.

2. Related Art

A fuel injector is a device for actively depositing fuel into an internal combustion engine by directly forcing the fuel into the combustion chamber at an appropriate point in the combustion cycle. For piston engines, the fuel injector is an alternative to a carburetor, in which a fuel-air mixture is drawn into the combustion chamber by the downward displacement of the piston. Current fuel injectors suffer from an inability to operate at high frequencies, which limits their applicability to advanced and emerging engine designs which operate at higher frequencies typically described in revolutions per minute (RPM). In addition, current injectors cannot easily vary the fuel delivery profile during an injection/combustion cycle, which further limits their inclusion in more sophisticated combustion configurations, particularly those operating at higher frequencies. Furthermore, current injector configurations have a response lag associated with various factors, including a displacement amplification requirement, which impedes higher frequency operation. Lag is a delay in response and will exist in both the control system and in the process or system under control. Finally, previous injectors which rely on piezoelectric actuation cannot directly actuate the flow control member that allows fuel to pass through an injection orifice into a combustion chamber due to an inability to move the flow control member a distance off its seat to allow fuel to flow at a selected rate. For purposes described herein, “direct” actuation is defined as the direct physical interaction of the prime actuating device with the primary flow control member which, when moved by the prime actuating device, immediately causes fuel to flow into the combustion chamber, typically through a nozzle portion. “Direct actuation” is further defined herein as having a one-to-one relationship between the actuating device and the flow control member with no additional interposing elements, amplification steps, flow channels, control pressures or other such ancillary elements to operate the flow control member.

Current piezoelectric stack actuator systems used in fuel injectors do not provide direct actuation of the nozzle assembly comprised of a valve and valve seat. Instead, the piezoelectric stack is typically used to simply open and close a separate valve. This separate valve is used to adjust the hydraulic pressure to assist in opening the primary valve of the nozzle assembly. This multi-step process of indirect hydraulic actuation and amplification creates an inherent limit to the operational frequency of the injector due to intrinsic response lag. Consequently, these dual stage piezoelectric injectors generally will not support the higher frequency operations of advanced and emerging engine technologies.

In current fuel injectors, a nozzle assembly portion is located adjacent the combustion chamber of the engine. The nozzle includes a pin, considered the primary flow control member, and an orifice to control flow of fuel into the combustion chamber. When the pin seats on a sealing portion of the orifice, fuel flow is cut off. When the pin is unseated from the sealing portion of the orifice, fuel flow is enabled.

In many existing injector configurations, hydraulic amplification is used to open and close the nozzle. High-pressure fuel is delivered to the nozzle compartment. The shape of the pin results in over-balanced pressure, causing the pin to be seated on the orifice in a closed position. An upstream actuator opens a pressure relief valve associated with the fuel delivery system, reducing pressure on one side of the pin; this results in a directional net linear force and causes the pin to lift off its seat and the nozzle to open. By closing the relief valve, pressure returns to its original level and the pin, typically assisted by a spring member, reseats to close the nozzle.

When a piezoelectric stack is used in the above manner, the overall system is mechanically and operationally more complex. Amplification of the displacement of the stack is required due to the extremely limited displacement of a piezoelectric stack relative to the displacement required to lift the pin a distance off its seat to enable the flow of fuel. This amplification typically requires more intricate flow arrangements within the body of the injector; additional valves; and, additional sealing elements. Hydraulic amplification can also introduce actuator response lag due to the multiple-step actuation process necessitated by displacement amplification. This response lag impedes the ability of a hydraulically amplified injector, even those using piezoelectric actuators, from operating at higher frequencies, such as those that might be required for pulse detonation engines or racing engines

Present injector actuation methods have other limitations. For example, many injectors operate in a binary fashion; i.e., either fully open or fully closed. It would be preferable to provide analog control of the fuel injection profile during an injection/combustion cycle. Where the injector operates only in a fully-open and fully-closed state, known as on/off operation, attempts have been made to obtain greater resolution of control by opening and closing the injector valve frequently and at differing durations during the course of an injection cycle. Unfortunately, this approach creates an even higher operational demand on the injector apparatus due to the multiplication of actuation cycles during each injection cycle.

Available displacement of the actuating means has an impact on how the actuating means might be used in the design of an injector. Two primary technologies used as “actuating” means, electromagnetic actuators and piezoelectric actuators, have substantially different available displacements, differing by several orders of magnitude. For example, electromagnetic actuators, also known as solenoids, can supply sufficient linear displacement of an injector pin to fully open a valve to deliver the desired fuel flow, but can operate only in two modes: fully open and fully closed. Fuel flow rate is typically controlled by one or more orifices in the nozzle of the injector. A solenoid valve is an electromechanical valve incorporating an electromagnetic solenoid actuator. The valve is controlled by an electric current through a solenoid. In some solenoid valves, the solenoid acts directly on the main valve. Others use a separate solenoid valve, known as a pilot, to actuate the larger valve, which enables the flow of fluid. Piloted valves require much less power to control, but are noticeably slower. Piloted solenoids also usually require full power at all times to open and remain open, whereas a direct acting solenoid may only require full power for a short period to open, and only low power to hold in a closed position. Irrespective of the type of solenoid used, the actuator will suffer from response lag, which is exacerbated as operational frequencies increase.

A second actuator type, using piezoelectric material to provide displacement, can provide faster response than a solenoid actuator, but has miniscule displacement. Generally, a standard piezoelectric stack made of piezoceramic material provides maximum displacement of 1/10^{th} of 1% of stack height; stacks made with single crystal piezoelectric material may provide displacement up to 1% of stack height. Consequently, heretofore, this limited displacement has forced piezoelectric actuation mechanisms in fuel injectors to be used only in an amplification configuration rather than to directly actuate the valve member that controls the flow of fluid through the valve. Necessarily, the prior piezoelectric injector configurations that rely on displacement amplification do not deliver direct actuation.

Various attempts have been made to increase or amplify the displacement of piezoelectric actuators. For example, a design known generally as a flextensional actuator includes a geometrically constrained piezoelectric actuator device that amplifies displacement along an axis perpendicular to the axis of displacement by using a constrained diamond-shaped enclosure. As the piezoelectric element contracts or expands in a horizontal direction, the external diamond-shaped enclosure also changes shape, causing the vertical vertices of the enclosure to move a slightly greater distance than the horizontal vertices, which are controlled by the piezoelectric element. Unfortunately, the inclusion of this mechanical feature introduces the limitation of a mechanical spring variable that may limit high frequency operation of the actuator and longevity. Additionally, this flextensional approach used to increase displacement also results in a decrease in the maximum force that may be applied by the stack. Further, the flextensional configuration is capable of increasing displacement by only a small amount and would require amplification if used as an actuator in a fuel injector.

Information relevant to other attempts to address the problems associated with the use of a piezoelectric actuator in a fuel injector can be found in U.S. Pat. Nos. 7,786,652; 7,455,244; 7,406,951; 7,140,353; 6,978,770; 6,834,812; 6,585,171; and 4,803,393. Each of these references fails to provide a solution for use of a piezoelectric actuator having minuscule displacement wherein the piezoelectric actuator directly drives the flow control member of the injector. Additionally, and in further detail, these references suffer from one or more of the following disadvantages, which will tend to impede high frequency operation and limit optimization throughout each combustion cycle to create maximum efficiency. These disadvantages include: (1) indirect actuation; (2) partial spring actuation; (3) complex mechanisms with a plurality of components and parts; (4) operation only in a fully-open or fully-closed position; (5) desired displacement distances which would require prohibitively long piezoelectric stacks; (6) one or more boosters to achieve opening forces; (7) actuating mechanisms unable to accommodate sufficient displacement; (8) inclusion of spring elements likely to induce valve float at higher frequency operation; (9) indirect actuation via hydraulic amplification resulting in lag and hysteresis; (10) no analog control of valve position; (11) inability to provide refined prestress on the piezoelectric stack to avoid placing it in tension; and (12) inability to adapt in real time to changing operating parameters or engine performance requirements. Additionally, these references fail to describe an injector having a one-to-one relationship between the prime actuating force and the flow control member; each describes interposing elements. Consequently, these other attempts do not provide direct actuation.

For example, Nakamura et al., U.S. Pat. No. 7,786,652 B2 issued Aug. 31, 2010, describes an injection apparatus using a multi-layered piezoelectric element stack. The invention disclosed by Nakamura et al. is directed to a need for a multi-layer piezoelectric element that can be operated continuously with a high electric charge without peel-off or cracking between the external electrode and the piezoelectric layer, which can lead to contact failure and device shutdown. The injector apparatus described by Nakamura et al. uses a needle valve sized to plug an injection hole to shut off fuel. The injector apparatus includes a spring underneath a piston valve member so that when power is removed from a piezoelectric actuator, the spring actually causes the valve to open and allow fuel injection. The stack only acts to close the valve. Furthermore, Nakamura et al. does not describe a method for prestressing the piezoelectric stack. General operation of the injector is either fully open or fully closed, with no ability to provide variable injection rates. The fuel flow rate is controlled by an orifice and is not adjustable. Additionally, it is unclear how the piezoelectric stack described by Nakamura et al. would provide sufficient displacement or contraction to move the needle sufficiently to unplug the injection hole, even with the inclusion of a supplementary spring. For the operational requirements associated with pulse detonation engines, the injector described by Nakamura et al. would neither enable sufficient flow nor operate at a sufficiently high frequency. Thus, the injector described by Nakamura does not have a one-to-one relationship between the prime actuating force and the flow control member; interposing elements are required. The injector of Nakamura is therefore not directly actuated.

Further, Boecking, U.S. Pat. No. 7,455,244 B2 issued Nov. 25, 2008, describes a piezoelectric fuel injector for injecting fuel into a combustion chamber of an internal combustion engine, wherein the injector includes a first and second booster piston, and the first booster piston is actuated using a piezoelectric stack to actuate the second booster piston which then moves a pin off seat to open the injection opening. The injector described by Boecking is directed to a need for a fuel injector of especially compact structure. Multiple springs within the injector body are used to generate closing forces. The system described by Boecking is a complex mechanism with insufficient displacement to move the pin sufficiently to support high volume fuel delivery. Due to the inclusion of spring-loaded elements, the described injector will suffer float at higher frequency operation. Additionally, Boecking's injector relies on the movement of a small needle valve, which will inhibit the ability to deliver flow at higher rates. Further, Boecking's injector does not have a one-to-one relationship between the prime actuating force and the flow control member; interposing elements are required. Hence, the injector of Boecking is therefore not directly actuated.

Stoecklein, U.S. Pat. No. 7,406,951 issued Aug. 5, 2008, describes a piezoelectric fuel injector for injecting fuel into an internal combustion engine wherein the fuel injector has an injection valve member that is indirectly actuated by a piezoelectric actuator. Stoecklein suggests that the injection valve member is “directly” actuated by the piezoelectric stack, but the description confirms that hydraulic amplification is used between the actuator and the injection valve. Hence, as defined herein, the injector of Stoecklein is not directly actuated. Additionally, the valve member relies on a spring element to move into a closed position. Stoecklein's invention also attempts to solve the problem in prior piezoelectric fuel injectors whereby intermediate positions of the valve between fully open and fully closed are unstable and cannot be maintained. Stoecklein describes a solution involving multistage hydraulic boosting of the actuator displacement to achieve stable intermediate stop positions. To overcome system pressure and open the valve member, an initial force is applied by reducing the current supply to the piezoelectric actuator. The shrinking length causes a pressure decrease in a hydraulic coupling chamber and, in turn, the control chamber. After a critical pressure has been reached, the valve opens to an intermediate displacement position. In order to achieve a complete opening of the valve member, the boosting is changed once the piezoelectric actuator has traveled a certain amount of its displacement distance.

Stoecklein's approach does not address issues of response lag nor adaptation to operate at high frequencies. Furthermore, although limited two-stage control is described, highly granular, essentially analog control is not supported by Stoecklein's injector system. As with the prior referenced designs, the injector includes springs that can cause valve float at higher operational frequencies. Stoecklein also confirms that a displacement of several hundred micrometers would be required to deliver desired flow rates, whereas the displacement available from reasonably sized stacks is about 20 to 40 microns. Additionally, the injector of Stoecklein must rely on a two-stage boost to achieve sufficient opening. As in the other referenced designs, Stoecklein's injector also does not have a one-to-one relationship between the prime actuating force and the flow control member; interposing elements are required. Hence, the injector of Stoecklein is not directly actuated.

Rauznitz et al., U.S. Pat. No. 7,140,353 B1 issued Nov. 28, 2006, describes a piezoelectric injector containing a nozzle valve element, a control volume, and an injection control valve for controlling fuel flow wherein a preload chamber is used to apply a preload force to the piezoelectric stack elements. Rauznitz et al. emphasizes the necessity of the hydraulic preload to prestress the piezoelectric stack to ensure reliable operation. As described, the injector of Rauznitz et al. operates only in an on/off mode, i.e., in fully-closed and fully-open positions. Hence, even though the injector may improve firing for opening and closing to address flow profile, it fails to provide analog control of the valve position to deliver highly granular control of the flow profile throughout each combustion/injection cycle. Additionally, opening and closing of the valve necessitates amplification with actuation of multiple components. Thus, the injector of Rauznitz et al. fails to provide direct actuation of the valve control member, limiting application in high frequency injection scenarios, and, fails to provide highly granular control of the fuel flow profile, limiting use, for example, in pulse detonation engines. Finally, the injector is designed to accommodate only smaller injector needles and would not support large injector sizes to accommodate increased fuel flow. Thus, the injector of Rauznitz et al. does not have a one-to-one relationship between the prime actuating force and the flow control member. Thus, interposing elements are required, resulting in an indirect actuation, not direct actuation.

Rauznitz et al., U.S. Pat. No. 6,978,770 B2 issued Dec. 27, 2005, describes a piezoelectric fuel injection system and method of control wherein the fuel injector contains a piezoelectric element, a power source for activating the element to actuate the injector, and a controller for charging the piezoelectric element directed to control of the injection rate shape. The system disclosed by Rauznitz et al. delivers closed, intermediate and fully open control. These three positions are further supported by rapid opening and closing of a nozzle valve element to create an improved rate shape. Precise control and analog positioning of the nozzle valve needle throughout its displacement is not possible. Furthermore, the injector uses springs to bias the valve element into a closed position, which introduces complexity and will cause the injector to suffer float at higher frequency operation. Thus, the injector of Rauznitz et al. does not have a one-to-one relationship between its prime actuating force and its flow control member; interposing elements are required. Hence, the injector of Rauznitz is not directly actuated.

Neretti et al., U.S. Pat. No. 6,834,812 B2 issued Dec. 28, 2004, describes a piezoelectric fuel injector directed to providing inward displacement of the valve to avoid external soilage. The valve is contained within an injection pipe and is moveable along its axis between a closed and an open position by expansion of the piezoelectric actuator. There are only two valve positions—fully open and fully closed—without the ability for analog or variable injection. A mechanical transmission is placed between the piezoelectric actuator and the valve in order to invert the displacement produced by expansion of the piezoelectric actuator and displace the valve in an inward direction. This mechanism adds complexity to the injector. Thus, the injector of Neretti et al. does not have a one-to-one relationship between its prime actuating force and the flow control member; interposing elements are required. Hence, the injector of Neretti et al. is not directly actuated.

Boecking, U.S. Pat. No. 6,585,171 B1 issued Jul. 1, 2003, describes a fuel injector system comprising a fuel return, high-pressure port, piezoelectric actuator stack, hydraulic amplifier, valve, nozzle needle, and injection orifice. The piezoelectric stack of the Boecking injector does not directly actuate the nozzle needle. Close examination reveals that the piezoelectric stack instead actuates a separate hydraulic amplifier to open the valve, which allows the nozzle needle to move off the injection orifice. The needle of the Boecking injector is not directly actuated by the piezoelectric stack. Furthermore, the Boecking injector is limited to operation in two discrete modes: on and off. Hence, Boecking's injector does not have a one-to-one relationship between its prime actuating force and its flow control member. Interposing elements are required and thus, the injector is not directly actuated.

Takahashi, U.S. Pat. No. 4,803,393 issued Feb. 7, 1989, describes a piezoelectric actuator for moving an object member wherein the actuator includes a piezoelectric element, an envelope having a bellows, and a pressure chamber where work oil is hermetically enclosed. The invention disclosed by Takahashi is directed to the need for an improved piezoelectric actuator that can prevent the breakdown of the piezoelectric element due to slanting attachments and defective sliding. This is achieved by an envelope between the piezoelectric element and the valve or object member, the envelope containing a resilient member and hermetically containing a fluid. The inclusion of the envelope and spring mechanisms in the injector of Takahashi introduces the problem of valve float at higher operational frequencies, along with indirect actuation limitations. Additionally, the piezoelectric actuator of Takahashi does not directly actuate the needle that controls flow; the actuator is used to move a separate upstream control valve that then allows flow to be delivered to the injector assembly. Hence, Takahashi's injector does not have a one-to-one relationship between a prime actuating force and the flow control member; interposing elements are required. Hence, the injector of Takahashi is not directly actuated.

Consequently, there exists a substantial unmet need for a piezoelectric fuel injector wherein the limited displacement of the piezoelectric actuator does not impose the need for amplification and is able to support fuel delivery requirements while directly actuating the flow control member. There exists a need for such a piezoelectrically driven fuel injector having rapid response afforded by direct actuation of an injector nozzle pin (flow control member) by a piezoelectric stack without interposing elements between the prime actuating force and the flow control member. There exists a further need for a piezoelectrically driven injector able to provide dynamic, controlled variable flow throughout an entire combustion/injection cycle, avoiding limitations to flow rate control resulting from simplistic on/off operation and selection of orifice size. There exists a still further need for a piezoelectrically driven fuel injector able to accommodate higher frequency cycling and higher pressure operating conditions. Additionally, there is a need for an injector able to operate at very high frequencies while having minimal latency and response lag. There is an additional need for a piezoelectrically driven, high frequency injector able to accommodate relatively high flow rates. There is a further need for an injector offering precise control over injection flow rates and the ability to accommodate various flow profiles despite miniscule actuator displacement.

### BRIEF SUMMARY OF THE INVENTION

In view of the foregoing described needs, an embodiment of the present invention includes a directly actuated piezoelectric fuel injection system having no interposing elements between the actuating mechanism, the piezoelectric stack, and, the flow control member. Thus, an aspect of the present invention delivers a functional injector despite miniscule displacement of the piezoelectric actuator. This direct actuation configuration significantly increases control of the fuel flow profile which directly improves fuel economy and reduces emissions in a plurality of engine systems. An embodiment of the present invention comprises a directly actuated piezoelectric injector apparatus that satisfies the above needs for a simplistic mechanism, rapid control response, minimal response lag, high frequency operation, the ability to accommodate high flow rates, ability to accommodate higher fuel supply and injection pressures, the capability to deliver variable control rate of flow throughout a combustion/injection cycle, precise control over flow rates, and the ability to accommodate various flow profiles while subjected to miniscule actuator displacement.

An embodiment of the present invention comprises a directly actuated fuel injector capable of operating in two modes. The first mode is on/off where the injector valve is either fully open or fully closed, with no intermediate state. The second mode is continuous where the injector valve can move between fully open or fully closed, or be held at any intermediate position. Continuous control is often called modulating control. It means that the injector valve is capable of moving continually to change the degree of valve opening or closing. It does not just move to either fully open or fully closed, as with on-off control. In the present injector, the flow control member serves as the opening and closing portion with the piezoelectric stack providing the force that can drive the flow control member either continuously or in an on/off mode.

An embodiment of the present invention is a directly actuated injector apparatus comprising a piezoelectric driving stack and a flow nozzle assembly wherein a flow control member of the injector apparatus is driven directly by the piezoelectric stack without interposing elements including additional amplification means while the flow area of the nozzle portion is variably adjustable with high resolution and granularity to deliver controlled flow rates in a desired flow profile. The injector is adapted to support desired flow rates with miniscule linear movement of the sealing portion of the flow control member away from a seating portion of the nozzle. Thus, the injector is able to accommodate the displacement limitations of piezoelectric actuating mechanisms.

Another embodiment of the injector assembly according to the present invention comprises a cylindrical housing, a cylindrical flow control member, a piezoelectric driving stack, and a flow nozzle portion wherein the flow control member is directly actuated the piezoelectric stack without additional amplification means or interposing elements. Drive electronics of the control system operate the piezoelectric stack; the drive electronics comprise a power amplifier, filters, and a processor providing custom design of a driving waveform and a user interface providing user control of said waveform in real time, along with management of the waveform via pre-programmed behaviour using software associated with the control system. The current and voltage delivered to the stack which establishes the amount of expansion or contraction from a prestressed state is controlled by these drive electronics. The drive electronics are suited to the control of the piezoelectric stack having miniscule displacement such that the flow control member can be moved a miniscule distance while the flow area can be adjusted with high granularity to deliver a desired fuel flow rate. We define miniscule displacement as displacement insufficient to enable desired flow without amplification of the displacement by secondary means.

The flow control member and nozzle portion according to an embodiment of the present invention are configured to provide a variably adjustable flow area to deliver controlled flow rates in a desired flow profile despite miniscule movement of the flow control member by the piezoelectric stack. Thus configured, the injector operates in both an on/off mode and a continuous or modulated mode. The injector is uniquely adapted to support desired flow rates with minimal linear movement of the flow control member away from a sealing seat of the nozzle. The actuating piezoelectric stack is placed in a pre-stressed state to ensure the piezoelectric stack is continually in compression during operation. In one aspect, the pre-stress is delivered by screwing the housing end cap down on top of the stack, thereby applying an initial downward force on the top of the piezoelectric stack. The initial downward force can be adjusted by tightening or loosening the end cap. The flow control member is unseated by a reduction in the piezoelectric stack driving force which, in combination with the contraction of the piezoelectric stack, allows the existing fuel pressure to assist to move the flow control member away from the seat of the nozzle, thus allowing fuel to flow into the combustion chamber at a prescribed rate as determined by fuel type, pressures and available flow area. The drive electronics and associated software are configured to support real-time adaptation over the life cycle of the injector to changes in physical and operational parameters. An embodiment of the present invention comprise an injector wherein the flow control member and sealing seat of the injector are create a continually conforming seal during use, wherein a desired flow rate and profile are maintained despite any change in flow geometry between a nose of the flow control member and the sealing seat. The software and drive electronics are configured to adjust the displacement of the piezoelectric stack in real-time to maintain the desired fuel flow profile supporting dual operating modes, including on/off and continuous.

### BRIEF DESCRIPTION OF THE SEVERAL VIEWS OF THE DRAWINGS

These and other features, aspects and advantages of various embodiments of the present invention will become better understood with regard to the following description, appended claims, and accompanying drawings where:

FIG. 1 shows a perspective view of an injector according to an embodiment of the present invention;

FIG. 2 shows an exploded view thereof;

FIG. 3 shows a cross-section view of the injector shown in FIG. 1, taken along the cutting plane 3-3;

FIGS. 3A, 3B, and 3C show an enlarged view of the cross-section of FIG. 3, wherein FIG. 3A shows the injector in a closed state, FIG. 3B shows the injector in an open state, and

FIG. 3C shows the displacement of the injector by superimposing the open state on the closed state;

FIGS. 4A and 4B show a cross-section view of the injector shown in FIG. 3, taken along the cutting planes 4A and 4B, respectively, wherein FIG. 4A shows the injector in a closed state and FIG. 4B shows the injector in an open state;

FIGS. 5A, 5B, 5C, and 5D show various nose profiles for the control member according to an embodiment of the present invention;

FIGS. 6A, 6B, and 6C show various inner nozzle surface curvature profiles for controlling annular flow through the injector according to an embodiment of the present invention;

FIGS. 7A, 7B, 7C, 7D, 7E, 7F, 7G, 7H, and 7I show enlarged views of a portion of the cross-section of FIG. 3 for flow control member displacement positions at (a) 0 micrometers (fully closed), (b) 5 micrometers, (c) 10 micrometers, (d) 15 micrometers, (e) 20 micrometers, (f) 25 micrometers, (g) 30 micrometers, (h) 35 micrometers, and (i) 40 micrometers (fully open);

FIG. 8 shows a cross-section view of the injector shown in FIG. 3, for multiple incremental intermediate displacement positions as shown in FIG. 7A-7I;

FIG. 8A shows a magnified view of the portion of FIG. 8 circumscribed by the line 8A-8A; and

FIG. 9 shows a chart of annular flow area and factor change in annular flow area as a function of flow control member displacement position for a conical flow control member of FIG. 5D according to an embodiment of the present invention.

FIGS. 10A, 10B, and 10C show enlarged views of a portion of the cross section of FIG. 3 illustrating deformation of the sealing seat edge over time and the creation of a self-seal, according to an embodiment of the present invention.

FIGS. 11A and 11B show enlarged views of the cross-section of FIG. 3 for flow area calculation, wherein FIG. 11A shows the injector in a closed state, and FIG. 11B shows the injector in an open state.

### OBJECTIVES OF THE INVENTION

A first objective of an embodiment of the present invention is to provide a directly actuated piezoelectrically driven injector capable of providing desired flow volume and granularity of control despite miniscule displacement of the flow control member by the piezoelectric actuator.

Another objective is to provide an injector capable of operating at a high frequency while maintaining integrity of sealing surfaces over a long operational life cycle via inclusion of a self-adapting conformable sealing surface.

Another objective is to provide a fuel injector capable of providing much greater control over fuel flow rate throughout the combustion cycle, thereby significantly improving fuel efficiency, substantially reducing the emission of harmful air pollutants, and enhancing power.

Another objective is to provide rapid fuel injector response to support high frequency operation along with highly granular control of rate of fuel flow during each injection cycle.

Another objective is to provide a fuel injector having the ability to operate at extremely high frequencies to support improved performance in advanced and emerging engine designs.

Another objective is to provide a fuel injector with the ability to vary the fuel delivery profile for each injection/combustion cycle, which further enhances desirability for inclusion in more sophisticated combustion configurations, particularly those operating at higher frequencies.

Another objective of the present invention is to provide a fuel injector having minimal control signal response lag further supporting use and operation at higher frequencies.

Another objective of the present invention is to provide a fuel injector having minimal control signal response lag to improve stability when incorporated into a closed-loop feedback control system, allowing controlled changes to be made both within and between injection cycles.

Another objective is to create a fuel injection device that is operated electronically rather than mechanically, eliminating the need for the plethora of mechanical components found in current engine configurations such as rotary valves, rocker arms, poppet valves, push rods, valve springs, camshafts, oil pumps, and other ancillary equipment to support mechanically-driven engine valve assemblies.

Another objective is to provide an operable injector using minimal linear movement of the actuating mechanism.

Another objective is to provide an injector with a minimal number of moving parts to increase operational longevity.

Another objective is to provide an injector where the actuator displacement is sized to avoid the inclusion of a sliding seal, thereby supporting the use of an elastomeric seal that wobbles rather than slides within the chamber of the injector.

Another objective is to provide an injector wherein the backpressure on the nozzle and flow control member of the injector can be adjusted via changes to a downstream flow orifice.

Another objective is to provide an injector capable of operating in both an on/off mode and a continuous mode.

Another objective is to provide an injector wherein the flow control member and nozzle shapes may be readily adjusted to deliver different flow profiles while using the equivalent piezoelectric actuating mechanism.

Another objective is to provide an injector wherein the surface of the nose of the flow control member and the sealing portion of the nozzle continually conform to each other during operation, their surfaces matching to ensure leak-free operation throughout the injector life cycle.

### DETAILED DESCRIPTION OF THE INVENTION

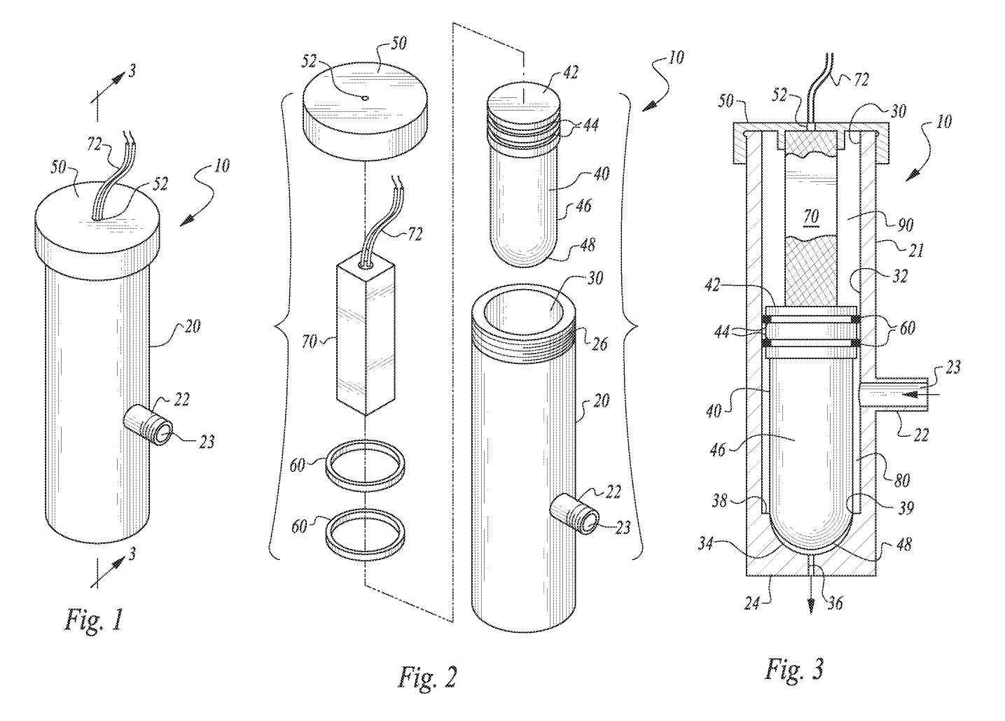

The following description is merely exemplary in nature and is in no way intended to limit the invention, its application, or its uses. As illustrated in FIG. 1, a fuel injector 10 serves as a flow control valve. According to an embodiment of the present invention, the fuel injector 10 includes an injector housing 20 having a circular end cap 50. As illustrated in FIG. 2, an exploded view of the injector 10 is shown including the injector housing 20 having an inner cylindrical chamber 30 for slidably receiving a cylindrical flow control member 40. A circular sealing member 60 comprised of circular seals circumscribes the circular top 42 of the flow control member 40 having cylindrical seal grooves 44 to create sealing engagement with an inner wall 32 of the inner cylindrical chamber 30. As shown, the seals 60 are rings to conform to the geometric profile of the flow control member 40 and inner cylindrical chamber 30. The seals 60 provide a pressure seal between a lower portion 80 of the inner cylindrical chamber 30 through which pressurized fuel flows and an upper portion 90 of the inner cylindrical chamber 30 that encapsulates the piezoelectric stack 70. The flow control member 40 is in direct contact with the piezoelectric stack 70. One skilled in the art would recognize that only one seal could be used, or a plurality of seals could be used, as dictated by pressure containment requirements. Additionally, various seal configurations could be further supported by the inclusion of other sealing material or fluids within the upper portion 90 of the inner cylindrical chamber 30 of the injector 10. Such fluid-based sealing options could incorporate a pressure compensation bladder to allow movement of the flow control member 40. Such fluid-based sealing options would also provide additional means for insulating the piezoelectric stack 70 by including a non-conductive fluid. The fluid-based sealing system could also provide a means for providing thermal control to the stack via insulating properties or heat transfer properties. Further, the sealing means could have different geometric shapes, such as chevron or other geometric seals used in hydraulic applications. Still further, the seals can be made of different deformable materials such as rubber, nylon, ceramic, elastomer, graphite, VITON, polyurethane, nitrile, metal and other such materials capable of separating the pressured fuel delivered via the lower portion 80 of the inner cylindrical chamber 30 from the upper portion 90 of the inner cylindrical chamber 30 encapsulating the piezoelectric stack 70.

Additionally, in light of the ability of the injector 10 according to an embodiment of the present invention to leverage a miniscule displacement of the flow control member 40 while providing annular flow area 37 to accommodate a desired flow rate, the seals 60 are essentially stationary where they engage the inner cylindrical chamber 30 of the injector housing 20 and the flow control member 40, such that the seals 60 themselves flexibly deform to accommodate the displacement d of the driven flow control member 40. This approach eliminates wear within the inner cylindrical chamber 30 and redirects any potential wear directly to the seals 60, thereby reducing the cost of maintenance where only the seals 60 need be replaced from time to time, rather than the injector housing 20 or its inner cylindrical chamber 30. Other seal types could be used to ensure a pressure seal within the injector housing 20 without departing from the spirit and scope of the various embodiments and aspects of the present invention.

A piezoelectric stack 70 acting as a driving member for controlling the position of the flow control member 40 within the inner cylindrical chamber 30 is interposed between the flow control member 40 and the end cap 50. The piezoelectric stack 70 retracts the flow control member 40 within the inner cylindrical chamber 30 of the injector housing 20 of the injector 10.

The injector housing 20 includes a body 21 with an inlet nozzle 22 penetrated by a flow passage 23 for ingress or receiving pressured fuel from an external fuel source (not shown). The injector housing 20 includes a bottom nozzle portion 24, and a top threaded portion 26 for attachment of the end cap 50 to the injector housing 20. As shown in FIG. 2, the flow control member 40 includes a circular top 42 above cylindrical seal grooves 44, and a body 46 having a hemispherical nose 48 with a first radius of curvature. The piezoelectric stack 70 includes conductors 72 for delivering electrical power to operate the piezoelectric stack 70. The end cap 50 includes a penetration 52 through which the conductors 72 exit the inner cylindrical chamber 30 of the injector housing 20 to connect to a separate control system (not shown) which powers the stack 70 to expand and contract at a desired frequency and displacement d. The control system includes software, drive electronics comprising a power amplifier, power filters, and a processor providing custom design of a driving waveform; and a user interface providing user control or software control of said waveform in real time based upon feedback from various sensors. The current and voltage delivered to the stack 70 via conductors 72 establishes the amount of expansion or contraction of the stack 70 from a prestressed state as determined and controlled by the drive electronics.

Additionally, the control system is adapted to support operation of the injector 10 in both a continuous and an on/off mode. The minimal lag intrinsic within the piezoelectric stack 70 supports higher frequency operation allowing the control system to deliver a driving waveform to operate the injector 10 at high frequency and with great granularity in movement of the flow control member 40.

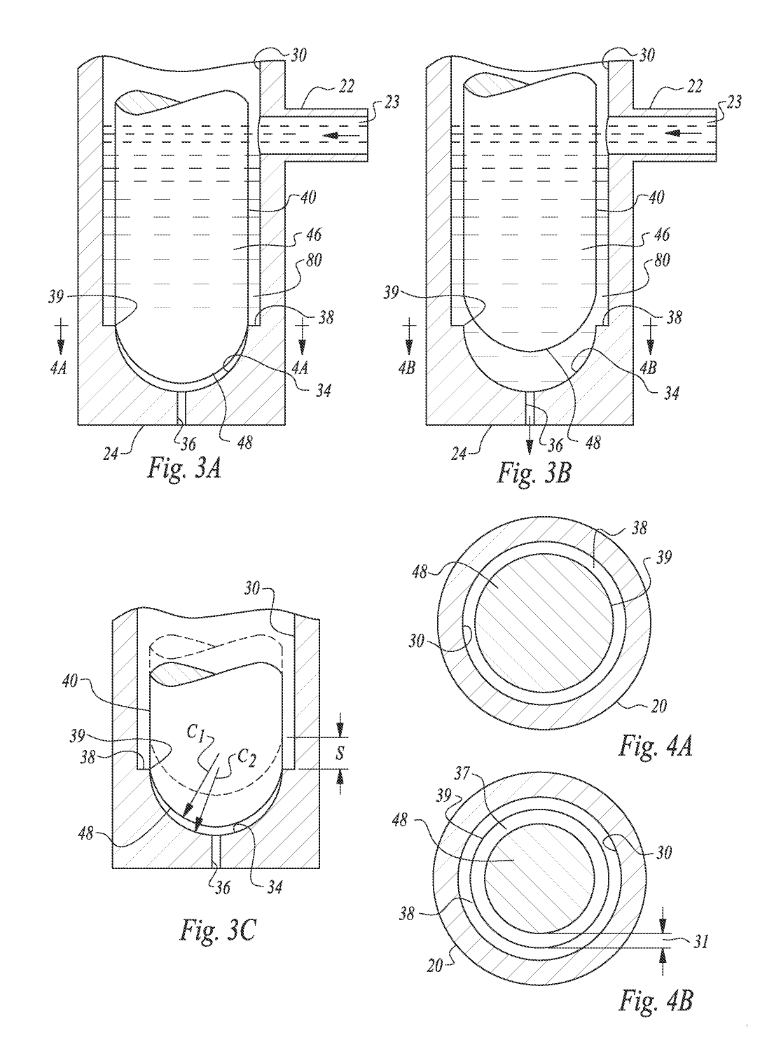

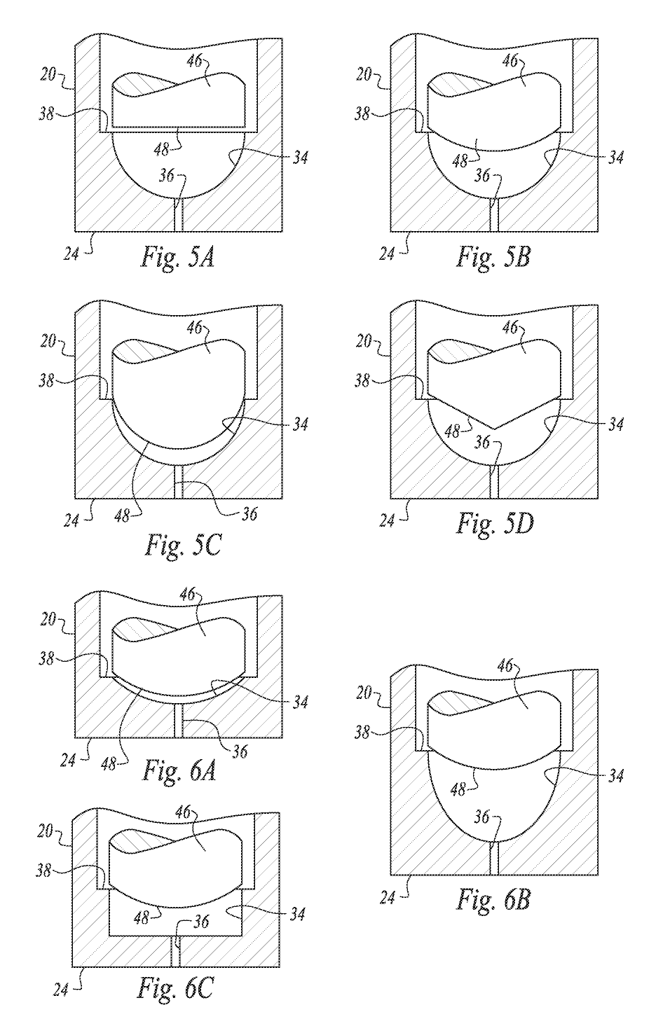

Now, in even greater detail, FIG. 3 provides a cross-sectional view of the assembled injector 10 shown in FIG. 1 taken along the cutting plane described by line 3-3. The injector housing 20 includes a body 21 with an inlet nozzle 22 having a flow passage 23 for receiving pressurized fuel into a lower portion 80 of the inner cylindrical chamber 30 of the injector 10. The injector housing 20 further includes a bottom nozzle portion 24 penetrated by an outlet nozzle 36 for egress of fuel from the injector 10 and through which fuel is delivered to the combustion chamber of an engine. The inner cylindrical chamber 30 includes an inner wall 32. Cylindrical seal grooves 44 of the flow control member 40 are sized to receive and seat circular seals 60 to create a seal between an upper portion 90 of the inner cylindrical chamber 30 and a lower portion 80 of the inner cylindrical chamber 30 that receives and transfers the pressurized fuel to an engine combustion chamber.

With reference to FIGS. 3A and 3B, the operation of the injector 10 is shown. In a closed state, as shown in FIG. 3A, the nose 48 of the flow control member 40 is seated against a sealing seat edge 39 of a sealing seat 38 of the inner cylindrical chamber 30 wherein the sealing seat 38 circumscribes the inner nozzle surface 34 and prevents the flow of fluid, i.e., fuel. The inner cylindrical chamber 30 includes a generally hemispherical inner nozzle surface 34 having a second radius of curvature smaller than a first radius of curvature of the nose 48 of the flow control member 40, causing the nose 48 and sealing seat edge 39 to create a limited sealing contact area which prevents fuel flow and lessens the force to disengage the flow control member 40 from the sealing seat edge 39 during opening. In this closed state, pressurized fuel resides in the lower portion 80 of the inner cylindrical chamber 30 formed by the body 46 of the flow control member 40, the sealing seat 38, and the seals 60 in the circular top 42 of the flow control member 40. In operation, with power removed from the stack 70, the stack 70 expands in a fail-safe mode to seat the flow control member 40 on the sealing seat edge 39 to interrupt fuel flow.

To reach an open state, as shown in FIG. 3B, the downward force delivered by the piezoelectric stack 70 is reduced to retract the nose 48 of the flow control member 40 away from the sealing seat 38. Once the stack 70 has retracted the flow control member 40, the force generated by the pressure of the fuel against the flow control member 40 provides a momentary additional opening force to assist in opening the injector 10. Once open, the position of the nose 48 of the flow control member 40 is controlled by the stack 70 to maintain a desired position in order to create a flow area appropriate to the desired flow rate. Pressurized fuel is then able to flow through the flow passage 23 of the inlet nozzle 22 into the lower portion 80 of the inner cylindrical chamber 30 and through the outlet nozzle 36 for egress into a combustion chamber (not shown).

The expansion or contraction of the piezoelectric stack 70 can be controlled with granularity to allow very precise control over the movement of the flow control member 40 resulting in very precise control over the rate of fuel flow. Coupled with the novel geometric configuration of the injector 10 based upon the first radius of curvature of the nose 48 of the flow control member 40 and the second radius of curvature of the inner nozzle surface 34, even more precise control rate of flow is afforded.

In operation, the fuel injector 10 creates a dynamic flow area that allows very precise variable control of fuel flow from the injector 10 into a combustion chamber. Precise control is afforded by direct actuation of the flow control member 40 by the piezoelectric stack 70, which allows controlled variability of an annular flow area 37 to provide variable fuel delivery profiles to optimize engine performance for efficiency, distance, power, velocity, emission control, or any combination of multiple performance objectives. Integration of the fuel injector 10 with other sensors, control circuitry, and operational intelligence will deliver enhanced engine and vehicle control, shifting engine component actuation methods from primarily mechanical actuation to primarily electronic actuation means.

As previously described and illustrated in FIG. 3A-3C, the injector 10 allows fuel to be delivered despite significantly reduced linear displacement d of the flow control member 40. In an embodiment of the present invention, the injector 10 leverages a first larger radius C1 of the nose 48 of the flow control member 40 juxtaposed against a second smaller radius C2 of the inner nozzle surface 34. Furthermore, the diameter of the flow control member 40 and associated inner cylindrical chamber 30 is sized to allow adequate fuel flow despite minimal linear displacement d of the flow control member 40. The surface profiles of the nose 48 of the flow control member 40 although shown as differing only in the radii of curvature represent only one variation of a plurality of available surface profiles which may be adapted for use in the injector 10.

In the present embodiment, the inner nozzle surface 34 includes an outlet nozzle 36 that penetrates the bottom nozzle portion 24 of the injector housing 20. The outlet nozzle 36 may be sized to limit flow of fuel to a prescribed upper limit or not limit the flow of fuel, irrespective of the flow enabled by the displacement of the flow control member 40. The outlet nozzle 36 may be sized to limit the flow to a prescribed upper limit. Consequently, an engine system can be designed to constrain maximum fuel flow to a specified limit. Additionally, in an additional embodiment, the outlet nozzle 36 can be removed in its entirety such that the fuel flow is determined solely by the displacement position of the flow control member 40 and the geometric relationship between the nose 48, the sealing seat 38, and the inner nozzle surface 34.

FIGS. 4A and 4B show cross-sectional views of the fuel injector 10 shown in FIGS. 3A and 3B, respectively, taken along the cutting planes described by lines 4A-4A and 4B-4B, respectively. With reference to FIG. 4A, the fuel injector 10 is shown in a fully closed state, wherein the nose 48 rests against the sealing seat edge 39, interrupting fuel flow. During operation when fuel is flowing through the injector 10, the sealing seat edge 39 may define an outer radius of the annular flow area 37. In the fully open state, shown in FIG. 4B, fuel flows through the annular flow area 37 formed when the piezoelectric stack raises the nose 48 to a displacement position such that the annular distance 31 is equal to the distance between a location on the nose 48 of the flow control member 40 closest to the sealing seat edge 39. Thus, the annular flow area 37 will be defined by the correlation between the sealing seat edge 39, the inner nozzle surface 34, and the surface of the nose 48 in closed proximity to either the sealing seat edge 39 or the inner nozzle surface 34.

With particular reference to FIGS. 11A and 11B, and for any inner nozzle surface 34 and nose 48 shape or profile, we describe the interplay between the flow control member 40 and the inner nozzle surface 34 where the corresponding annular flow area 37 at any height h along the inner nozzle surface 34 and for any displacement d, may be determined. For purposes herein, since the desired shape of the nose 48 of the flow control member 40 can be changed to accommodate various flow profiles, it is desirable that the flow control member 40 is displaced to a displacement position wherein an annular flow area 37 is presented to allow minimum fuel flow at all times during operation. Additionally, in different aspects of the present invention, the nose 48 of the flow control member 40 may be shaped to create a seal at other locations along the inner nozzle surface 34, rather than the sealing seat edge 39.

In operation, the separation between the nose 48 and inner nozzle surface 34 is set to provide a minimum operational fuel flow when operation is initiated, except in the case where fuel flow is completely interrupted and the nose 48 of the flow control member 40 is seated at some point along the inner nozzle surface 34 to establish a closed state. Consequently, nose 48 and inner nozzle surface 34 must have cooperative shapes that deliver the desired minimum annular flow area 37 during operation. A specific design for the nose 48 or inner nozzle surface 34 can be qualified by a designer by ensuring that this minimum flow area is available through the operational range of the stack 70. Hence, the annular flow area 37 at any given height h of the flow control member 40 wherein the height h is defined as any position, in the single axis of motion of the flow control member 40, between the sealing seat 38 and the outlet nozzle 36, is described by the relationship:

A_{flow}(h)=π·rₒᵤₜₑᵣ₍ₕ₎²−π·r_{inner(h+d)}²

Where A_{flow(h)} is the annular flow area 37 in μm² at a specified height h; rₒᵤₜₑᵣ₍ₕ₎ is the radius of the circle in μm defined by the profile of the inner nozzle surface 34 at the specified height h. For h=0, this circle corresponds to the sealing seat edge 39. Further, r_{inner(h+d)} is the radius of the cross-sectional circle circumscribing the points on the nose 48 of the flow control member 40 at any height h and for any displacement d of the stack 70 from a closed position. For h=0 and d=0, this also corresponds to the sealing seat edge 39, which establishes the closed position of the injector 10. By definition, where rₒᵤₜₑᵣ₍ₕ₌₀₎ and r_{inner(h=0+d=0)} are equal, then the annular flow area 37, A_{flow(h=0)}, is also 0.

With reference to this equation, the annular flow area 37 will vary along the length of the inner nozzle surface 34 and the nose 48 of the flow control member 40 with variations in height h. Consequently, one may use this relationship as a design variable which can be modified and controlled to impact flow rate and smoothness of flow allowing decisions which will enable turbulent or laminar flow characteristics, as preferred for the particular application and operating environment. The annular flow area 37 is dependent upon the profile of both the inner nozzle surface 34 and the profile of the nose 48 of the flow control member 40, as each varies with height h, as well as to the displacement d of the stack 70, and hence displacement d of the flow control member 40. By careful selection of the profile of each of these components, in conjunction with knowledge of stack displacement d, a designer can control the geometric configuration and rate of change of the annular flow area 37 support selected operational requirements.

With reference to FIGS. 11A and 11B, the effective radii of the flow control member nose 48 and inner nozzle surface 34 for flow area calculation at any specific location is shown. The available annular flow area 37 through the injector 10 changes with the height h along the inner nozzle surface 34 and displacement d.

FIG. 11A shows the injector 10 in a closed state. The displacement d in this state, represented by d₁, is 0; h₁ represents the height h in the closed state. The initial height h and initial displacement d, represented by h₀ and d₀, respectively, are both 0. FIG. 11B shows the injector 10 in an open state, after the stack 70 and flow control member 40 have moved a displacement d₂. The height in this state is represented by h₂.

As an exemplar, with reference to FIG. 3C, an embodiment of the present invention described herein cites profiles corresponding to specific radii of curvature, with a radius C1 of the flow control member 40 being larger than a radius C2 of the inner nozzle surface 34. One will recognize that the shape or profile of the nose 48 and inner nozzle surface 34 of the injector housing 20 need not be limited to these particular variations. More complex geometries, straight surfaces, even undulating surfaces designed to alter flow drastically with stack displacement d may be incorporated without departing from the spirit of the invention. Further, rᵢₙₙₑᵣ and rₒᵤₜₑᵣ can remain constant or even increase with increasing height h as long as the annular flow area 37 available supports the minimum fuel flow requirements at any given displacement d. Additionally, the surface of each section need not be axisymmetric, that is identical through the full 360 degree rotation, and alternative surfaces or alternative shapes such as spiral grooves may be incorporated in the configuration of either the nose 48 or the inner nozzle surface 34 to alter flow as desired, including flow rate, flow profile, flow type and flow pattern.

With reference to FIG. 5A-5D, the nose 48 of the flow control member 40 is shown as having various shapes or profiles for controlling annular fuel flow through the injector 10. Each profile exhibits a different rate of change in annular distance 31 and, therefore, annular flow area 37, as the flow control member 40 is raised from a fully closed position to a fully open position. In a flat nose profile as shown in FIG. 5A, the annular distance 31 is a direct function of the displacement position of the flow control member 40. Curved profiles for the nose 48 of the flow control member 40 shown in FIGS. 5B and 5C exhibit a non-linear relationship between the change in annular flow area 37 and the flow control member 40 displacement position d. This non-linear relationship is a function of the profile of the nose 48. The relationship is linear for a conical profile as shown in FIG. 5D.

With reference to FIG. 6A-6C, various inner nozzle surface 34 profiles for controlling annular fuel flow through the injector 10 are shown. These various inner nozzle surface 34 profiles can be adapted to provide a plurality of fuel flow characteristics. Although not shown herein, the injector 10 can include an inner nozzle surface 34 profile that is unrestrictive such that all fuel flow is controlled by the annular flow area 37, wherein the annular flow area is a function of displacement position d and shape of the nose 48 of the flow control member 40.

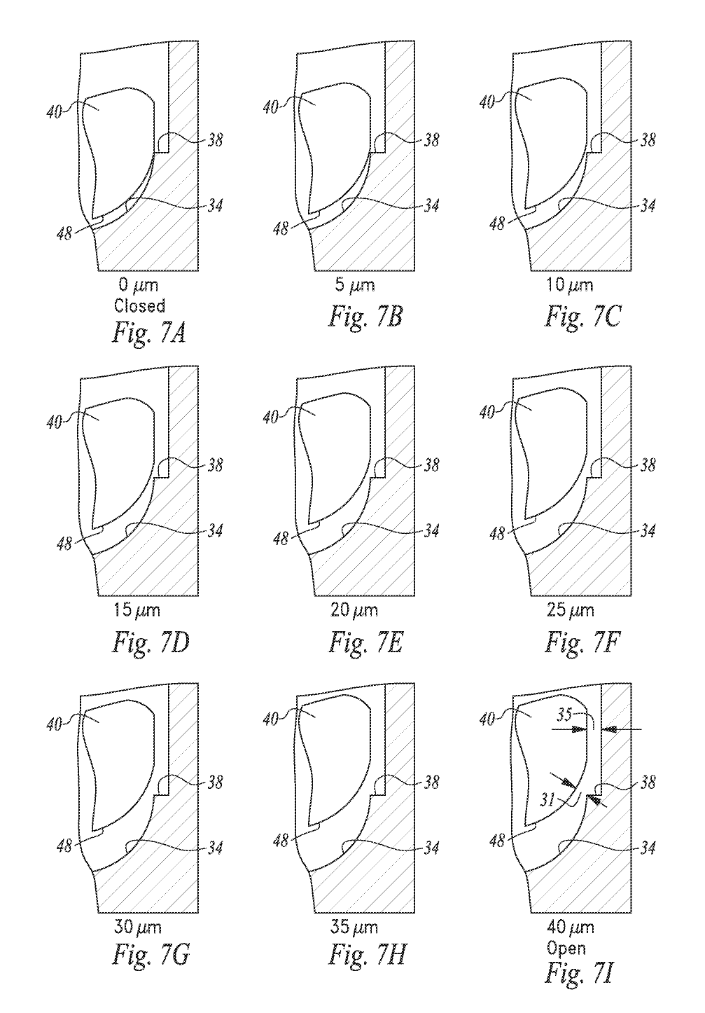

FIG. 7A through 7I illustrate a first embodiment of the injector 10 wherein the nose 48 of the flow control member 40 is translated linearly by the piezoelectric stack 70 to various intermediate displacement positions within the inner cylindrical chamber 30 of the injector housing 20. Now, described in series, FIG. 7A shows a cross-sectional view of the body 46 of the flow control member 40 in the fully closed state. In this state, the displacement position is defined as 0 microns. The flow control member 40 is in contact with the sealing seat 38 at the sealing seat edge 39, interrupting fuel flow through the injector 10. FIGS. 7B, 7C, 7D, 7E, 7F, 7G, and 7H show additional intermediate displacement positions of the flow control member 40 in 5 micron increments as the body 46 of the flow control member 40 is translated linearly away from the sealing seat 38 to incrementally increase the annular flow area 37, allowing corresponding incrementally increased fuel flow. Thus, the correspondence between fuel flow profile and shape of the nose 48 of the flow control member 40 is a function of the displacement positions. The flow control member 40 will reach a final position corresponding to the total displacement of the piezoelectric stack 70 and corresponding to a maximum annular flow area 37. Although shown herein for exemplary purposes only as adjustable in 5-micron increments, depending on the capability of the drive electronics, the piezoelectric stack 70 of the injector 10 is capable of essentially analog, continuous control of the displacement position of the flow control member 40.

The annular distance 31, annular flow area 37, and fuel flow rate increase as a function of the displacement position of the body 46 of the flow control member 40. FIG. 7I shows the body 46 of the flow control member 40 in a fully open state, at a displacement position of 40 microns. In this state, the annular distance 31 is equal to the flow gap 35, which is the distance between the body 46 of the flow control member 40 and the inner wall 32 of the inner cylindrical chamber 30. Above this upper displacement position, fuel flow is controlled by the flow gap 35.

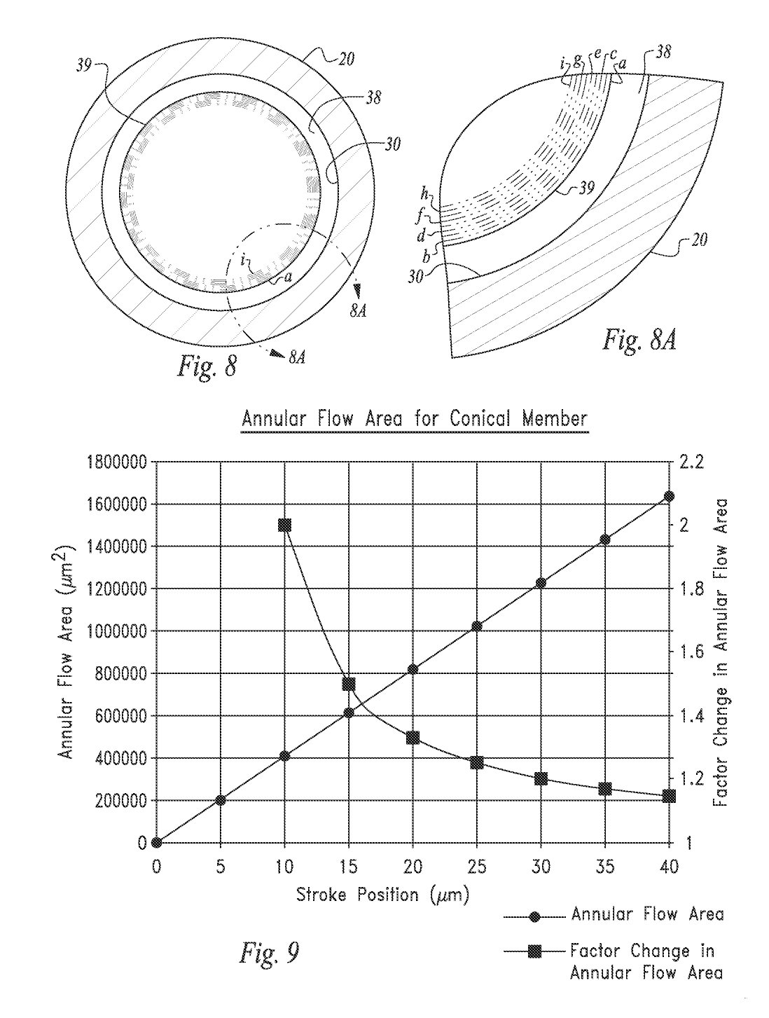

FIG. 8 provides a representation of a cross-sectional view of the fuel injector with the body 46 of the flow control member 40 translating linearly from a fully closed state, a, to a fully open state, i, with changes in the annular flow area 37 at each increment of 5 microns. Although shown herein for exemplary purposes as operating in 5-micron increments, the piezoelectric stack 70 actually contracts or expands in an analogue manner in proportion to the electric voltage applied to the stack 70.

The amount of contraction or expansion of the piezoelectric stack 70, hereinafter, displacement d, is adjustable to accommodate various implementation scenarios and operating requirements. The piezoelectric stacks 70 used in injector 10 can operate with displacement increments on a sub-nanometer scale given an appropriate applied voltage. The size of the displacement increment is therefore limited only by the driving electronics, not the piezoelectric stack 70. Increment size is determined by the maximum applied voltage of the electronics and the quality of the digital to analogue signal conversion.

For example, an 8-bit digital to analogue conversion supports 255 distinct positions, while a 16-bit digital to analogue conversion supports 65535 distinct positions. The injector 10 enables modification of the operation of the piezoelectric stack 70 through design and selection of the drive electronics, which may also be impacted by cost. As electronics improve, the injector 10, associated software, and drive electronics can be adapted to further enhance the granularity of the displacement d of the piezoelectric stack 70 and flow control member 40 through enhanced control of the piezoelectric stack 70 or stacks 70.

While displacement d of the piezoelectric stack 70 is determined by the applied voltage, the rate of change of displacement d, which determines operational frequencies of the injector 10, is driven by the rate at which the drive electronics supply the required voltage charge to the piezoelectric stack 70. The greater the required speed of change to support specific operating frequencies, the greater the electrical charge to be delivered; the drive electronics are adapted to accommodate variable operational frequencies.

The injector 10 will accommodate a range of typical operating frequencies for various injection systems, which may operate upward to frequencies of several hundred Hertz (Hz) or even thousands of Hz. Hence, the operational frequency of the injector 10 could be designed for a range between just a few Hz and 1000 Hz. Design alterations and modified electronics will allow significant increase in operating frequencies of the injector. Further, the drive electronics and associated software support a plurality of changes in displacement d during each injection cycle, providing enhanced granularity and support of optimal performance where operational enhancement is achieved via delivery of adjustments during each injection cycle.

The drive electronics and associated software also detect and identify operational limitations of each piezoelectric stack 70 based upon the natural resonant frequency of each individual piezoelectric stack 70. This detection capability prevents the piezoelectric stack 70 from operating at frequencies that might quickly degrade operation of the injector 10. For stable operation, most systems will require the frequency of operation to be below the resonant frequency of the piezoelectric stack 70. The piezoelectric stacks 70 of the injector 10 are selected such that the resonant frequencies are 40 kHz or above. Hence, where the operating frequency of an engine is in the range of 200 Hz, the injector 10 avoids approaching this critical frequency. The injector 10 and drive electronics are matched to create waveforms to drive the piezoelectric stack 70 at frequencies from 0 Hz to 1000 Hz, and, the piezoelectric stack 70 and drive electronics are optimally matched to leverage these higher drive frequencies and responsiveness of the piezoelectric stack 70 thereby reducing control signal response lag to improve operational stability of the injector 10 when the injector 10 is incorporated with the drive electronics in a closed-loop feedback control system to allow controlled changes in operation to be made both within and between cycles. Where the injector 10 is adapted to other operational parameters and requirements, other alterations to the stack 70 can be implemented to avoid operating within a resonant frequency window. For example, in extreme cases where a large piezoelectric stack 70 is used to deliver significant displacement at high frequencies, the resonant frequency may be approached. For example, an 800 mm piezoelectric stack 70 would have a resonant frequency in the low kHz regime, such as around 2 kHz. If operational frequency were in the 1 kHz range, this frequency proximity would be undesirable, necessitating other changes to the piezoelectric stack 70 to raise the resonant frequency.

FIG. 8A is an enlarged view of that portion of FIG. 8 circumscribed by the curved line 8A-8A. The dotted lines a through i define the boundaries of the annular flow area 37 for 5 micron incremental intermediate displacement positions of the flow control member 40. It is critical to note that the 5 micron increment has been selected simply to ease description of the various features and capabilities of the injector 10, and, that the actual granularity of movement for the injector 10 is limited only by the capabilities of the stack 70 and the associated drive electronics. The stack 70 is capable of moving the flow control member 40 in sub-nanometer increments, establishing a displacement resolution limit associated with the injector 10.

Line a, corresponds to sealing seat edge 39, wherein the flow control member 40 is fully engaged and interrupting flow, showing the fuel injector 10 in a fully closed state. At a, the annular flow area 37 is 0 square microns and the nose 48 of the flow control member 40 is set against the sealing seat edge 39 of the sealing seat 38, preventing fuel flow. Additional dashed lines b, c, d, e, f, g, and h represent successively greater intermediate displacement positions, in 5-micron increments. The annular distance 31 and resulting annular flow area 37 increase as the displacement position increases, wherein the relationship is defined by the profile of the nose 48 of the flow control member 40 and the profile of the inner nozzle surface 34. Line i represents an annular distance 31 associated with flow control member 40 of the fuel injector 10 in a fully open state based upon the available displacement capacity of the piezoelectric stack 70. In the present embodiment, the annular distance 31 is equivalent to the distance between the surface of the nose 48 of the flow control member 40 and the sealing seat edge 39.

In various configurations, the annular flow area can be a limiting or non-limiting aspect. In one aspect, where the injector 10 is in a fully open state with the nose 48 of the flow control member 40 positioned a maximum distance from the inner nozzle surface 34, the inner wall 32 of the inner cylindrical chamber 30 has a larger diameter such that the annular distance 31, is at a maximum but is less than the distance between the inner wall 32 and body 46 of the flow control member 40. In another aspect, the inner wall 32 of the inner cylindrical chamber 30 has a smaller diameter such that the annular distance 31 is at a maximum and greater than the distance between the inner wall 32 and body 46 of the flow control member 40.

With reference to FIG. 9, the relationship between displacement positions a through i of the body 46 of the flow control member 40 and the annular flow area 37 for a conically-shaped nose 48 illustrated in FIG. 5D is shown in a graphical format. As displacement position increases, the annular flow area 37 also increases. In addition, as the displacement position increases, the incremental factor change in annular flow area 37 decreases non-linearly with increasing displacement position. The factor change in annular flow area 37 is defined as the ratio of the difference between the annular flow areas 37 associated with two neighboring displacement positions divided by the greater annular flow area 37 of the first displacement position. By modifying the flow profile of the nose 48 of the flow control member or the shape of the inner nozzle surface 34, the incremental factor change in annular flow area as a function of the displacement of the piezoelectric stack can be modified. As a result, the fuel flow profile can be controlled with increased granularity or more coarsely, as desired. Hence, the inclusion of a feature to support an interchangeable nose 48, interchangeable flow control member 40, and interchangeable inner nozzle surface 34 delivers more flexibility in application of the injector 10, wherein alternate shapes for each may be provided.

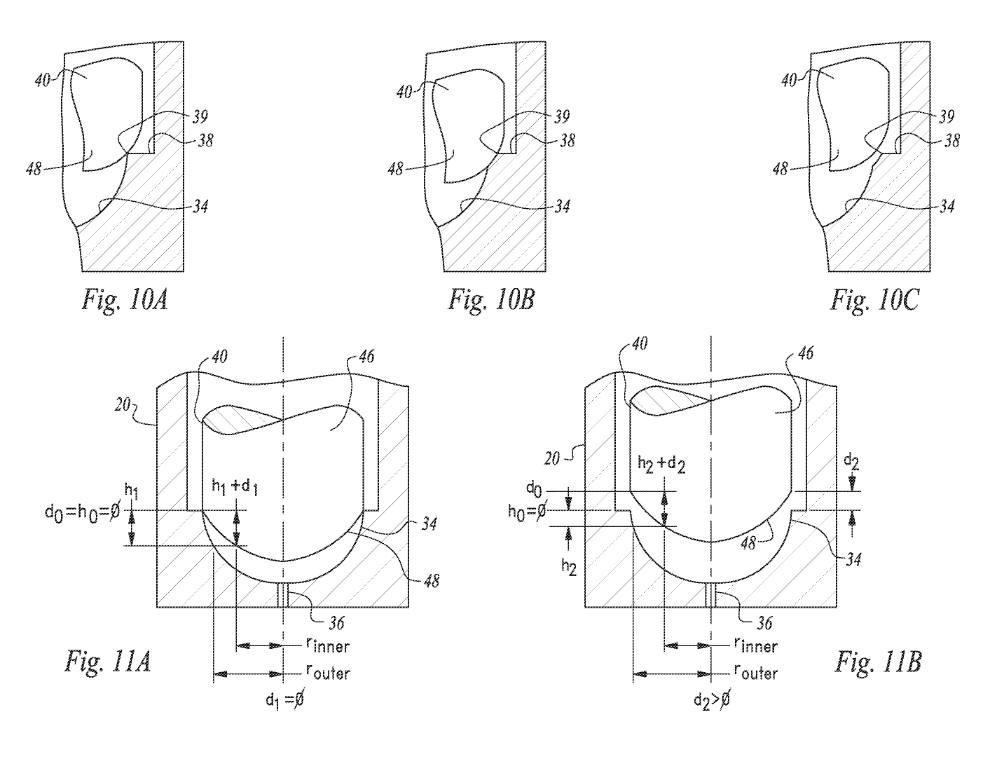

With reference to FIG. 10A-10C, the sealing seat edge 39 of the injector 10 is shown at various states of deformation. FIG. 10A shows the sealing seat edge 39 in the initial manufactured state, without deformation caused by operation, forming a seal with the nose 48 of the flow control member 40 to prevent fuel flow. During operation, repeated actuation of the flow control member 40 by the piezoelectric stack 70 between closed and open states causes wear and deformation of the sealing seat edge 39. FIG. 10B shows the sealing seat edge 39 in a state of deformation after a number of cycles. A conforming self-seal is formed by the geometry of the sealing seat edge 39, the nose 48 of the flow control member 40, and the downward force applied by piezoelectric stack 70 on the body 46 of the flow control member 40. The material of the inner nozzle surface 34 is selected to be softer than the material used in manufacturing the flow control member 40. Hence, in the event that the sealing seat edge 39 becomes deformed to a state where the stack 70 is unable to accommodate the deformation, the inner nozzle surface 34 of the inner cylindrical chamber 30 may be replaced. The linear translation of the flow control member 40 provided by the piezoelectric stack 70 is controlled by the drive electronics and sensors and will accommodate the increased displacement due to deformation associated with establishment of a seal against the sealing seat edge 39 to prevent fuel flow. FIG. 10C shows the sealing seat edge 39 in its deformed state in an open position. The effects of deformation on the resulting annular flow area 37 and corresponding fuel flow rate are compensated for by adjusting the displacement d of the flow control member 40 by means of the drive electronics and feedback sensors to maintain the desired fuel flow rate through the injector 10.

Now, the rationale for the design and operation of the injector 10 is described. First, to accommodate miniscule displacement of the flow control member 40 from the sealing seat 38 caused by the use of a piezoelectric stack 70 as a direct actuator of the flow control member 40, a novel nonconforming flow control configuration is described. In prior injector configurations, the flow control member of a fuel injector, commonly known as a “pin” or “needle,” has a diameter just slightly larger than the orifice through which fuel is jetted into the combustion chamber of an engine. The pin in a conventional injector is simply used to shut flow on and off, and hence, the orifice serves as the primary means of flow control. Consequently, prior injector configurations cannot adjust flow without changing the size of the orifice. This limitation prevents these earlier solutions from delivering real-time dynamic changes in the orifice to accommodate varying fuel types, deformation of the sealing area, varying operating conditions, or varying performance requirements.

For one set of operating parameters used herein, including operating pressures and desired fuel flow rate, in a conventional injector, the pin (flow control member) is sized to close off an orifice having a diameter of approximately one mm. However, in stark contrast, in the present embodiment of the invention, the body 46 of the flow control member 40 has a diameter of approximately 15 mm. One skilled in the art would recognize that the diameter of the flow control member 40 may be adapted to various flow requirements, and can be scaled up or down as desired.

Thus, the injector 10 of the present embodiment of the invention takes a directly contrary approach to conventional injector configurations by distinctly modifying the physical size and relationship between the flow control member 40 and the displacement of the flow control member 40 made available by the piezoelectric stack 70. The displacement d of the piezoelectric actuator stack 70 is typically tens of microns. Hence, to accommodate a desired flow rate, the injector 10 of the present invention is sized to accommodate a much larger flow control member 40 to provide a significantly greater annular flow area 37 around a nose 48 of the flow control member 40. The available flow area is driven by the annular flow area 37 presented as the nose 48 of the flow control member 40 is translated linearly away from the sealing seat 38 of the inner nozzle surface 34 by the piezoelectric actuating stack 70.

In the present embodiment, in one version as shown in FIG. 3A-3C, the available flow area is determined by the smallest annular cross-section presented by the geometric difference between the nose 48 having a first radius of curvature C1 and the inner nozzle surface 34 having a second radius of curvature C2. As the stack 70 contracts to move the nose 48 of the flow control member 40 in an upward direction, the available flow area increases as a function of the geometric relationship between the nose 48 and the inner nozzle surface 34, including the sealing seat 38 and sealing seat edge 39. Hence, the available flow area as a function of available displacement d of the stack 70 may be adjusted by changing the shape of the nose 48, the shape of the inner nozzle surface 34, or both.

In comparison, for conventional fuel injectors having a needle diameter slightly greater than 1 mm and effective orifice diameter of 1 mm, where the exposed orifice area is considered independent of the displacement d, the calculated flow area of a 1 mm diameter orifice is 0.125 sq. mm. Based upon desired flow rates, pressures, and an initially selected fuel of JP-10, this flow area alone is insufficient to achieve the desired flow rates associated with the operation of a preferred pulse detonation engine. Hence, in a conventional injector, the small flow control member, in this case, the “pin” or “needle,” is a bottleneck that is not adjustable without completely replacing the orifice. This prior injector nozzle configuration is not dynamically adaptable.

When considering various size constraints and operating parameters, the height of the piezoelectric stack 70 determines the available displacement d. By expanding the diameter of the flow control member 40 significantly, a desired effective flow rate can be maintained despite miniscule displacement d of the stack 70.

The injector housing 20 readily adapts to a range of operational needs. While the exemplar is shown as accommodating piezoelectric stacks 70 having a total length of 40 millimeters, this length can be reduced to accommodate smaller injector sizes and reduced displacement d. Alternatively, the length of the injector housing 20 may also be increased to accommodate larger piezoelectric stacks 70, which will deliver both a longer displacement d, and greater force. Further, the injector housing 20 can accommodate piezoelectric stacks 70 of smaller total size than the maximum space available in the injector housing 20 via the use of stiff spacers to fill the remaining void between the flow control member 40 and the end cap 50. The total length available in the injector housing 20 can also be filled with one or more stacks 70 in any combination. For example, for a 40 mm total stack length, a single 40 mm stack could be used; two piezoelectric stacks of 20 mm, one 30 mm stack and one 10 mm stack, or any other such combination, including spacers, totaling 40 mm.

In a multi-stack arrangement, the stacks 70 can be connected electrically in parallel to singular drive electronics such that the stacks 70 act in unison to maximize displacement d. Alternatively, one or more of the stacks 70 can be connected to separate drive electronics. In this manner, each of the stacks 70 may be operated independently in different applications. For example, by electrically driving each stack 70 independently, one or more of the stacks 70 can be used to prestress the remaining stacks 70 dynamically, supporting adaption to current operational environmental parameters and system requirements. Since the upper portion 90 of the inner cylindrical chamber 30 of the injector housing 20 does not contain fluid under pressure, the injector 10 also supports adaptation of a modular approach such that the injector housing 20 can be constructed in one or more sections. This modular configuration can also reduce machining requirements of long components. When one or more stacks 70 are operated in series, the total displacement of the multiple stacks 70 is equivalent to the sum of individual displacements of each separate stack.

In operation, and as one representative example, to accommodate desired fuel flow rates for a pulse detonation engine operating on JP-10 fuel, a first embodiment of the injector 10 according to the invention uses a flow control member 40 having a diameter of 15 mm. A diameter of 15 mm is selected to also accommodate a square cross section of the selected piezoelectric stack 70 having side dimensions of 10 mm×10 mm (approximately 14 mm across diagonally) with a total displacement d of 40 microns. This correlation between the size of the piezoelectric stack 70 and the diameter of the flow control member 40 is selected herein as one of a plurality of desirable design points that will deliver appropriate performance in a suitable package size for inclusion in various engine applications.

As illustrated in FIG. 3C, in the present embodiment of the invention, the nose 48 of the flow control member 40 has a greater first radius of curvature C1 than the second radius of curvature C2 of the inner nozzle surface 34. The annular flow area 37 prescribed by the separation of the profile of the nose 48 of the flow control member 40 from the profile of the inner nozzle surface 34 varies directly with the linear translation and displacement d of the stack, thus providing highly granular, analog control of flow. While the stack 70 provides highly resolute motion of the flow control member 40, the inclusion of a nose 48 with a specific profile and an inner nozzle surface 34 having a specific profile further serves to increase the granularity of flow control of the injector 10 and the shape of the fuel flow profile. The operational flow profile of the injector 10 can be adjusted by modifying the curvature of the nose 48 and the inner nozzle surface 34, while using the same piezoelectric stack 70 with the same displacement d. FIG. 5A-5D and FIG. 6A-6C are representative versions of the various nose profiles and inner nozzle surface profiles, respectively, that might be deployed in different configurations of the injector 10 to deliver differing fuel flow profiles as a function of the displacement d of the piezoelectric stack 70. Pluralities of variations on these base configurations are possible. Consequently, the operational performance of the injector 10 may be adjusted by changing flow control members 40 wherein each flow control member 40 may have a different nose 48, by changing the inner nozzle surface 34, or both. Although shown herein as comprising several different variations, embodiments of the present invention are not limited to these specific geometric shapes and are adaptable to a plurality of nose 48 and inner nozzle surface 34 profiles and shapes. Additionally, although shown herein as consisting of a single module, the injector housing 20 may include modular components including outlet nozzles 36 that are modular with differing inner nozzle surfaces 34 which can be screwed or otherwise attached to the bottom nozzle portion 24 of the injector housing 20.

In the present embodiment, the injector 10 is shown as including an outlet nozzle 36, the outlet nozzle having a smaller diameter in comparison to a larger diameter of the flow control member 40 and nose 48. The flow control member 40 and nose 48 geometrically interact with the sealing seat edge 39 of the sealing seat 38 and the inner nozzle surface 34. Alternative embodiments of the present invention do not include an outlet nozzle 36 and flow is controlled solely by the geometric interaction between the nose 48 and sealing seat edge 39 of the sealing seat 38. As previously discussed and illustrated in FIG. 6A-6C, other embodiments would include differently shaped inner nozzle surfaces 34 which would likewise adjust flow rate and pattern. In other aspects of an embodiment of the present invention, the outlet nozzle 36 is sized to limit flow or configured to provide a desired fuel flow spray pattern or droplet size. Additionally, the outlet nozzle 36 can include a means for attachment of the injector 10 to an engine combustion chamber via the inclusion of a threaded, flanged or bolted interface at the bottom nozzle portion 24. Further, in other embodiments, the outlet nozzle 36 can be modular and removable from the injector 10. Still further, the outlet nozzle 36 in a removable, modular form could be used to serve as an additional means for adjustably or fixedly prestressing the piezoelectric stack 70 in a manner similar to that of an end cap 50, wherein an adjustable desired prestress load is delivered to the piezoelectric stack 70 via rotation of a threaded outlet nozzle 36 to compress the stack 70 via the placement of pressure on the nose 48 of the flow control member 40.

Additionally, although tested with a 50 bar supply line connected to the inlet nozzle 22, the injector 10 can be readily modified to accommodate different supply pressures. Further, although the injector housing 20 according to an embodiment of the present invention accommodates piezoelectric stacks 70 having side dimensions of 10×10 mm with a stack height of 20 to 40 mm, the injector housing 200 can be scaled up or down to accommodate differing stack sizes and flow requirements.

During installation, the end cap 50 is screwed onto the top of the injector housing 20 using the top threaded portion 26 to seal the injector 10 and apply a prestress compression to the stack 70. Other means for attaching the end cap 50 and adjusting the desired prestress load would be suitable including the use of finer threads, the inclusion of geared micrometers to control the resolution of the rotation of the end cap, the inclusion of geared stepper motors to automate the control and rotation of the end cap 50, and other such devices that could precisely control the placement of an adjustable or fixed desired prestress load on the piezoelectric stack 70.

The injector 10 is configured to operate at high combustion operating temperatures and high pressure, as well as with volatile fuel and corrosive chemicals. In the president embodiment, stainless steel was chosen as the preferred material for mechanical and chemical robustness along with ease and practicability of machining. Other materials, including ceramic, would be suitable and adaptable for particular operational requirements.

Referring once again to FIG. 3, in operation, the piezoelectric stack 70 controls the linear movement of the flow control member 40 within the injector housing 20. In testing the injector 10, a displacement d of approximately 40 microns is generated using an operational voltage of 200 volts applied to the piezoelectric stack 70. In one embodiment, a single crystal piezoelectric stack 70 comprising 200 single crystal layers, wherein the stack 70 is 20 mm long will meet these operational parameters. In a second embodiment, a standard piezoelectric stack having an approximate height of 40 mm is used to achieve the desired displacement d of approximately 40 microns. Essentially, for existing piezoelectric materials comprised of piezoceramic material, the displacement d available is approximately one-tenth of one percent of the height of the piezoelectric stack, assuming delivery of sufficient electrical power to the stack. The housing 20 of the injector 10 is able to accommodate both a 20 mm and 40 mm stack height where a rigid spacer is placed between the end cap 50 and the top of the stack 70 to fill the remaining space where a 20 mm stack is used. Although a stack 70 composed of single crystal piezoelectric material is substantially more expensive than a stack composed of standard piezoelectric materials, a single crystal piezoelectric stack 70 will allow the injector 10 to be significantly reduced in size since a single crystal piezoelectric will deliver strain of 1% of the stack height. As manufacturing costs drop with increased production volume, single crystal stacks will be the preferred choice for use in the injector 10.

The injector housing 20 will accommodate one 20 mm long single crystal stack, one 40 mm standard piezoelectric stack, or two 20 mm single crystal stacks, or two or more stacks of differing heights totaling 40 mm. In addition, where a longer stack is preferable to support other operating parameters, the injector housing 20 may be expanded to hold multiple stacks in either series or parallel configurations. When the stack design incorporates two 20 mm single crystal stacks, the stacks may be aligned to increase displacement d, where the total displacement is the sum of individual displacements. Alternatively, the stacks may be aligned in opposing orientations such that one stack contracts in one direction while the remainder contracts in another direction, such that each stack delivers force in opposition to the other stack. This opposing contraction provided allows one stack to function as a means for providing both initial and real-time adjustment of prestress on the primary actuating stack. Consequently, the end cap 50 may be used to establish initial prestress while a second stack is used to provide a more resolute and fine-tuned control of prestress. Additionally, the second stack may be used to adjust prestress as the housing 20 of the injector 10 expands or contracts due to the housing material's thermal coefficient of expansion. Further, the second stack may be used to accommodate extension of the stack 70 caused by operational deformation of the sealing seat edge 39.

In use and operation, compressive prestress forces are placed on the stack 70 to ensure the piezoelectric crystal layers are never placed in tension, where the ceramic piezoelectric material is weaker and the bonds between layers are weaker. In most circumstances, prestress is applied to a piezoelectric stack prior to insertion in a system; in an embodiment of the present invention, prestress is applied to the stack 70 after insertion of the stack 70 in the injector housing 20. By applying a desired prestress load after the stack 70 is deployed within the housing 20 of the injector 10, differing means may be used, as discussed above, to adjust the load on the stack 70 during operation to provide real-time calibration during differing operating scenarios.

Initial desired prestress load is applied to the stack 70 via a threaded end cap 50 attached to a top threaded portion 26 of the injector housing 20. The end cap 50 can be tightened or loosened to vary the prestress on the stack 70. The ability to adjust and vary the prestress load ensures that there is a downward force on the flow control member 40 to resist opposing opening forces caused by high pressures associated with the combustion cycle and associated fuel supply pressure. We determined that the downward force on the stack 70 to keep the flow control member 40 closed at 50 bar (6 MPa) is well within the operable stress range of the piezoelectric materials used in the stack 70. Since the stack 70 is initially prestressed and in compression with downward force placed on the flow control member 40 to keep it seated with fuel flow shut off, to operate the injector 10 and lift the flow control member 40 off the sealing seat 38, the stack 70 is powered such that it contracts further than it existing compressed state. This powering method ensures that the stack 70 is never placed in tension, which would likely damage the stack 70 early in its operational life cycle.

In the present embodiment, the injector 10 accommodates multiple variables associated with control of fuel delivery. In addition, the injector 10 includes an additional means for controlling flow via inclusion of an outlet nozzle 36. The outlet nozzle 36 can be sized to either limit or not limit flow. In one aspect, the diameter of the outlet nozzle 36 is sized to satisfy desired flow rates for the selected engine system, while simultaneously providing an upper flow limit or governing mode. When set in a particular governing mode to control an upper fuel flow rate, the diameter of the outlet nozzle 36 is determined based on fuel supply pressure, desired maximum flow rate, and fuel properties. For example, in a specific operational test to support pulse detonation engine operation, JP-10 fuel was selected as the preferred fuel type. JP-10 fuel is an aviation turbine fuel and due to its properties is the primary missile fuel used in the U.S. today.

The thermophysical properties of JP-10 fuel are given in a report by T. J. Bruno et al, entitled Thermochemical and Thermophysical Properties of JP-10, published June 2006. For the contemplated design of pulse detonation engine, the desired fuel flow rate and operating temperature was set at 35 g/s of JP-10 fuel at 300° F. with a minimum desired operating injection frequency of 100 Hz, where each cycle constitutes a full open and close of the valve. In the Bruno report, the sound speed and most other physical quantities are given in the temperature range of 270 K-345 K. At the specified temperature of 300° F. (420 K), most of the physical quantities must be extrapolated. Extrapolating the sound speed curve, the sound speed at 420 K is 975 m/s. For the desired flow requirements, the discharge flow velocity at 200 bars is estimated to be 250 m/s, which is substantially lower than 975 m/s. Consequently, the flow rate of the fuel is in the incompressible range and compressibility effects can be neglected.

For liquid discharge flow through an orifice, the flow rate, q, is given by

q=CA\sqrt{2g144Δp/ρ}

where q is the volumetric flow rate in ft³/s, C is the dimensionless discharge coefficient (approximately 1, depending on the orifice-to-pipe diameter ratio and the Reynolds number (Re), A is the flow area in ft², g is a units conversion factor (=32.17 lbm-ft/lbf-s²), Δp is the driving overpressure in psi, and ρ is density in lbm/ft³. Other related units conversion factors are: for density, 1 g/cc=1 kg/m³=62.4 lbm/ft³; for pressure, 1 bar=14.50 psi; for viscosity, 1 mPa-s=10⁻³ g/s-mm=0.000672 lbm/ft-s; and for mass, 1 lbm=453.515 g.

The extrapolated density of JP-10 fuel at 420° K is 0.85 kg/m³ (53 lbm/ft³). C_{d}=0.98 for Re ˜5×10⁴ which is 0.2% below the asymptotic value of 0.982 for fully turbulent flow. The viscosity extrapolates to 0.68 mPa-s.

The disclosed injector 10 will provide opportunities for substantial improvement in many types of combustion engine designs, significantly improving fuel efficiency and reducing emissions. The size of the injector 10 can be scaled down or up to accommodate varied injection requirements. Standard diesel and jet engines stand to benefit greatly from the superior capabilities of this fuel injector technology due to an ability to deliver analog control of flow. In addition, pulse detonation engines, having unique and rigorous operational requirements that heretofore have been previously unmet, now have a greater opportunity to become a legitimate and viable engine modality using various embodiments of the present invention.

Further, the injector 10 according to various embodiments of the present invention will serve as foundational and pioneering technology to support substantial redesign of today's combustion engine technologies. An important outcome associated with the use of this electronically-controlled, direct actuation piezoelectric injector configuration is the opportunity to eliminate a plethora of existing engine components including rocker arms, push rods, valve springs, cam shafts, timing belts, and associated equipment. These components could be supplanted by one or more versions of the described piezoelectrically driven injector 10.

Although various embodiments of the present invention have been described in considerable detail with reference to certain preferred versions thereof, other versions are possible. For example, a version may be configured such that the inner nozzle surface 34 and the outlet nozzle 36 are removed with flow controlled by the annular gap between the nose 48 of the flow control member 40 and the sealing seat 38. In addition, another version can include adaptations, modifications and adjustments to size of the flow control member 40, shape of the nose 48, and shape of the inner nozzle surface 34 to deliver alternative flow characteristics as a function of stack displacement d. Additionally, versions of the present invention can include multiple stacks which allow further adjustment of the power and displacement of the stack 70 where multiple stacks in parallel increase overall power or force and multiple stacks in series increase overall displacement. Multiple stacks or larger stacks are easily accommodated by increasing either the length or the diameter of the injector housing 20. In addition, versions are possible wherein a second load or prestress adjustment stack is interposed between the end cap 50 and a first driving stack 70 to provide real-time adjustment of prestress on the driving stack 70. Multiple piezoelectric stacks 70 in parallel relation can be used to adjust alignment of the flow control member 40 within the cylindrical chamber 30 of the injector housing 20. Additionally, multiple stacks 70 can be used to skew and vibrate the flow control member 40 as a means of mechanically cleaning any scale or deposits that might accumulate during operation. Still further, an injector 10 according to an embodiment of the present invention hereof can include an operational approach wherein the piezoelectric stack 70 or an ancillary piezoelectric stack is driven at frequencies which would resonate and cause scale and other deposits to be cleaned from the inner cylindrical chamber 30, the inner wall 32, the inner nozzle surface 34, the outlet nozzle 36, the sealing seat 38, and the sealing seat edge 39. In light of the plurality of versions and embodiments of the present invention described above, the spirit and scope of the appended claims should not be limited to the description of the preferred versions contained herein.

The reader's attention is directed to all papers and documents which are open to public inspection with this specification, and the contents of all such papers and documents are incorporated herein by reference. All the features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “steps for” performing a specific functions, is not to be interpreted as a “means” or “step” clause as specified in 35 U.S.C. Sec. 112, par. 6

### INDUSTRIAL APPLICABILITY

Embodiments of the present invention are applicable to all internal combustion engines using a fuel injection system. Embodiments of the present invention are particularly applicable to diesel engines that require accurate fuel injection control by a simple control device to minimize emissions. It is further applicable to advanced engine designs, including gas turbines, and pulse detonation engines, where accurate, high frequency control with delivery of fuel at high rates and with a specific profile during each cycle is desired. In its versions, embodiments, and aspects, the present invention is further applicable to gasoline or ethanol powered combustion engines where it is desirable to replace many moving parts in favor of a simple, electronically-control fuel injection system capable of reducing emissions while improving overall performance. Such internal combustion engines which incorporate a injector in accordance with an embodiment of the present invention can be widely used in all industrial fields, commercial, noncommercial and military applications, including trucks, passenger cars, industrial equipment, stationary power plants, airborne vehicles, rockets, jets, missiles, and others.

We claim:

1. A fuel injector comprising:
(a) an injector housing having a cylindrical chamber therein, said cylindrical chamber having an inner nozzle surface providing egress from said cylindrical chamber;
(b) an inlet nozzle attached to said injector housing and providing ingress into said cylindrical chamber;
(c) a flow control member seated within said cylindrical chamber to control flow of fuel through said inner nozzle surface;
(d) a seal circumscribing said flow control member creating a pressure seal;
(e) a sealing seat, said sealing seat having a sealing seat edge;
(f) a piezoelectric stack joined to said flow control member such that said flow control member is driven directly by said piezoelectric stack; and
(g) drive electronics connected to said piezoelectric stack for driving said flow control member.

2. The fuel injector as recited in claim 1, said flow control member further comprising:
(a) a circular top;
(b) one or more cylindrical seal grooves; and
(c) a body having a hemispherical nose, said nose having a first radius of curvature.

3. The fuel injector as recited in claim 1, said cylindrical chamber further comprising:
(a) a bottom nozzle portion;
(b) said bottom nozzle portion including an inner nozzle surface; and
(c) said inner nozzle surface having a second radius of curvature.

4. The fuel injector as recited in claim 3, wherein said sealing seat circumscribes said inner nozzle surface.

5. The fuel injector as recited in claim 4, wherein said sealing seat edge is deformable such that said sealing seat edge conforms to a nose of said flow control member.

6. The fuel injector as recited in claim 1, further comprising:
(a) said flow control member having a nose;
(b) said nose having a first radius of curvature;
(c) said cylindrical chamber having a bottom nozzle portion;
(d) said bottom nozzle portion including an inner nozzle surface; and
(e) said inner nozzle surface having a second radius of curvature.

7. The fuel injector as recited in claim 6, wherein said second radius of curvature is less than said first radius of curvature.

8. The fuel injector as recited in claim 1, said drive electronics further comprising:
(a) a power amplifier, power filters, and a processor providing custom design of a driving waveform;
(b) a user interface providing user control of said driving waveform via pre-programmed behavior;
(c) said flow control member driven continuously by said drive electronics to one or more intermediate displacement positions;
(d) said flow control member driven by said drive electronics in increments to one or more intermediate displacement positions; and
(e) said flow control member driven by said drive electronics to a fully open position and a fully closed position.

9. The fuel injector as recited in claim 8, wherein said waveform drives said piezoelectric stack at frequencies between 0 Hz to 1000 Hz, and, said piezoelectric stack and said drive electronics configured to leverage said drive frequencies of said piezoelectric stack thereby reducing control signal response lag to improve operational stability of said fuel injector when said injector is incorporated with said drive electronics in a closed-loop feedback control system to allow controlled changes in operation to be made both within and between injection cycles.

10. The fuel injector as recited in claim 8, wherein an annular flow area varies as a function of said displacement.

11. The fuel injector as recited in claim 10, wherein said annular flow area varies linearly and proportionately with said displacement positions.

12. The fuel injector as recited in claim 10, wherein a factor change in annular flow area varies linearly with said displacement positions.

13. The fuel injector as recited in claim 12, wherein a factor change in said annular flow area is nonlinear with respect to said displacement positions of said flow control member.

14. The fuel injector as recited in claim 10, said annular flow area determined by:
(a) a shape of a nose of said flow control member; and
(b) said displacement positions of said flow control member.

15. The fuel injector as recited in claim 14, further comprising an interchangeable nose to provide an alternative shape to support one or more fuel flow profiles as a function of said displacement positions of said flow control member.

16. The fuel injector as recited in claim 15, said shape of said interchangeable nose being any of planar, rounded, hemispherical and conical.

17. The fuel injector as recited in claim 15, further comprising an interchangeable inner nozzle surface to support one or more fuel flow profiles wherein said fuel flow profiles are determined as a function of displacement positions of said flow control member.

18. The fuel injector as recited in claim 17, further comprising an interchangeable nose to support one or more fuel flow profiles as a function of displacement positions of said flow control member.

19. The fuel injector as recited in claim 14, said shape of said nose of said flow control member being variable, selectable and interchangeable, thereby allowing a designer to select a desired shape to deliver a desired fuel flow profile and a desired fuel flow spray pattern.

20. The fuel injector as recited in claim 1, said inner nozzle surface further comprising an outlet nozzle sized to limit flow of fuel to an upper limit.

21. The fuel injector as recited in claim 1, said piezoelectric stack configured to retract said flow control member away from said sealing seat edge to create an annular distance defining an annular flow area.

22. The fuel injector as recited in claim 1, said piezoelectric stack configured to drive said flow control member through a plurality of incremental intermediate displacement positions creating a corresponding annular flow area for each of said plurality of incremental intermediate displacement positions, each said corresponding annular flow area defined by said sealing seat edge and a location on a nose of said flow control member in closest proximity to said sealing seat edge at said each of said plurality of incremental intermediate displacement positions.

23. A fuel injector as recited in claim 22, wherein said plurality of intermediate incremental displacement positions is determined by drive electronics and a displacement resolution limit imposed by said piezoelectric stack.

24. A fuel injector for injecting fuel into a combustion chamber of an engine comprising:
(a) an injector housing;
(b) an inlet nozzle attached to said injector housing for receiving pressurized fuel;
(c) said injector housing have a bottom nozzle portion;
(d) an outlet nozzle positioned at said bottom nozzle portion of said injector housing providing an egress into the combustion chamber;
(e) a piezoelectric stack positioned inside said injector housing;
(f) a control system and drive electronics connected to said piezoelectric stack providing power to expand and contract said piezoelectric stack; and
(g) a flow control member in direct contact with said piezoelectric stack within said injector housing, said piezoelectric stack providing for direct actuation and displacement of said flow control member, said flow control member moveable between a closed state in which fuel flow from said inlet nozzle through said outlet nozzle into the combustion chamber is blocked and a plurality of intervening open positions wherein fuel flows through said outlet nozzle at a plurality of differing flow rates.

25. The fuel injector as recited in claim 24, wherein a position of said flow control member within said injector housing is variable in accordance with expansion and contraction of said piezoelectric stack such that a rate of fuel flow is proportional to the expansion and contraction of said piezoelectric stack.

26. The fuel injector as recited in claim 25, wherein said flow control member includes a nose having a first radius of curvature and said injector housing includes an inner nozzle surface of said bottom nozzle portion of said injector housing, said inner nozzle surface having a second radius of curvature.

27. The fuel injector as recited in claim 26, wherein an annular flow area is created between said nose of said flow control member and said inner nozzle surface by a displacement of said flow control member away from said inner nozzle surface wherein said annular flow area is a function of said first radius of curvature, said second radius of curvature and said displacement of said flow control member within said injector housing.

28. The fuel injector as recited in claim 27, wherein a diameter of said flow control member is selected as a function of said displacement of said flow control member within said injector housing and said annular flow area to accommodate a desired fuel flow rate.

29. The fuel injector as recited in claim 27, wherein a change in said annular flow area as a function of said displacement of said flow control member is determined by a shape of said nose of said flow control member and a shape of said inner nozzle surface to accommodate a desired fuel flow profile.

30. The fuel injector as recited in claim 24, wherein said flow control member is moveable between an open state and a closed state such that said displacement is one percent of a height of said piezoelectric stack and a diameter of said flow control member is greater than a diameter of said outlet nozzle, such that a flow rate established by said outlet nozzle is greater than a flow rate controlled by an annular flow area.

31. A fuel injector for variably injecting fuel into a combustion chamber comprising:
(a) an injector housing;
(b) an inlet nozzle attached to said injector housing for receiving pressurized fuel;
(c) an outlet nozzle positioned at a bottom nozzle portion of said injector housing providing an egress into the combustion chamber;
(d) a piezoelectric stack positioned inside said injector housing, said piezoelectric stack being subjected to a prestress load;
(e) a flow control member coupled to said piezoelectric stack within said injector housing, said flow control member variably moveable by said piezoelectric stack between a closed state in which fuel flow from said inlet nozzle through said outlet nozzle is blocked and an open state in which fuel flows from said inlet nozzle through said outlet nozzle in relationship to expansion and contraction of said piezoelectric stack; and
(f) drive electronics connected to said piezoelectric stack for driving said flow control member via expansion and contraction of said piezoelectric stack.

32. The fuel injector as recited in claim 31, wherein said fuel injector is made from materials able to withstand combustion operating temperatures and corrosive chemicals, such materials including stainless steel and ceramic.

33. The fuel injector as recited in claim 32, wherein a nose of said flow control member is made of material such that a sealing seat and a sealing seat edge deform preferentially to said nose of said flow control member.

34. A valve comprising:
(a) a housing having a body;
(b) a flow control member having a nose, the flow control member annularly disposed within said body such that the flow control member is linearly translatable within said housing;
(c) a piezoelectric stack for driving said flow control member; and
(d) a sealing seat, said nose of said flow control member causing a seal to interrupt flow when seated on said sealing seat.

35. A valve operable to allow or prevent the flow of fluid to or from a chamber, said valve comprising:
(a) a cylindrical flow control member linearly translatable within a body of said valve and a circular sealing member, said cylindrical flow control member and said circular sealing member defining an annular flow area therebetween for the flow of fluid therethrough; and
(b) a valve moving member for moving said flow control member axially between one or more positions, a first position in which said flow control member is in sealing engagement with said circular sealing member to close said annular flow area to the flow of fluid therethrough, a plurality of additional intermediate positions in which said flow control member is positioned incrementally from said circular sealing member so that said annular flow area is open to the flow of fluid therethrough, and a final position in which said flow control member is positioned a maximum distance from said circular sealing member to establish a total displacement of said valve moving member and a maximum annular flow area for said valve.

36. The valve as recited in claim 35, wherein said valve moving member comprises a plurality of piezoelectric stacks.

37. The valve as recited in claim 36, wherein said valve moving member further comprises at least two piezoelectric stacks, said at least two piezoelectric stacks positioned mechanically in series, wherein said total displacement is a sum of individual displacements for said at least two piezoelectric stacks.

38. The valve as recited in claim 36, wherein at least one of said one or more piezoelectric stacks is energized to apply force in opposition to force exerted by a remainder of said one or more piezoelectric stacks.

39. The valve as recited in claim 35, wherein said flow control member preferentially deforms said circular sealing member during operation of said valve.

40. The valve as recited in claim 35, wherein said total displacement of said valve moving member is less than an outer radius of said annular flow area.

41. A flow control valve comprising:
(a) one or more piezoelectric stacks;
(b) a flow control member connected to said one or more piezoelectric stacks;
(c) said flow control member movably disposed within a housing;
(d) said flow control member including a nose;
(e) a sealing member within said housing; and
(f) said piezoelectric stack driving said flow control member to one or more positions within said housing such that a shape of said nose and a shape of said sealing member creates an annular flow area, said annular flow area controlling a rate of flow.

42. The flow control valve as recited in claim 41, further comprising a pressure seal, said pressure seal deformable to accommodate movement of said flow control member within said housing.

43. The flow control valve as recited in claim 42, wherein said pressure seal is made of deformable material.

44. The flow control valve as recited in claim 43, wherein said deformable material is selected from any of graphite, elastomer, nylon, nitrile, polyurethane, Viton and metal.

45. A valve comprising:
(a) a housing,
(b) a flow control member; said flow control member including a pressure seal;
(c) a driving member to movably position said flow control member within said housing wherein a displacement of said driving member is constrained to a miniscule displacement;
(d) a sealing member sized to engage said flow control member so as to interrupt flow through the valve; and
(e) said flow control member and said sealing member sized to provide flow area to support a desired fuel flow rate wherein said flow control member is moveable away from said sealing member a distance within said miniscule displacement of said driving member.
